(19) United States
(12) Patent Application Publication
(10) Pub. No.: US 2005/0210726 A1
(43) Pub. Date: Sep. 29, 2005

(54) Locking mechanism for label/sign holder

(76) Inventor: Jacob Fast, Boca Raton, FL (US)

Correspondence Address: JACOBSON HOLMAN PLLC, 400 SEVENTH STREET N.W., SUITE 600, WASHINGTON, DC, 20004, US

(21) Appl. No.: 11/088,966

(22) Filed: Mar. 24, 2005

Related U.S. Application Data
(60) Provisional application No. 60/556,893, filed on Mar. 29, 2004.

(51) Int. Cl. G09F 3/18

(52) U.S. Cl. 40/661.03; 40/649

(57) ABSTRACT

A label holder including a transparent cover member overlying a main body panel to form a label-receiving pocket and a locking mechanism to releasably lock the cover member with respect to the main body portion. The locking mechanism is formed by two elongated planar facing ridges lying parallel to each other and integrally formed with the cover member and the main body portion. A release element is integrally formed with the cover member. Disengagement results from an outwardly directed force component on the release element to enable the ridges to bend with respect to each other and thus disengage. The release element has different angular orientations with respect to the plane defined by the label holder cover member.

This is a complete application claiming benefit of provisional application Ser. No. 60/556,893 filed Mar. 29, 2004.

### BACKGROUND OF THE INVENTION

1. Field of the Invention

This invention relates to label holders of the kind used, for example, with merchandise display shelves in retail outlets such as supermarkets, drug stores, or the like, to receive labels providing information relating to merchandise being displayed on the shelves. More specifically, this invention is directed to a label holder with a locking transparent window or cover member of the type shown in commonly owned U.S. Pat. No. 5,515,632 issued May 14, 1996, the subject matter of which is incorporated herein in its entirety by reference (the '632 patent) and a locking mechanism for a combined label/sign holder of the type shown in commonly-owned U.S. Pat. No. 6,568,112 issued May 27, 2003 (the '112 patent), also incorporated herein in its entirety by reference).

2. Description of the Related Art

In the '632 patent, the transparent cover member of a plastic label holder is hingedly and resiliently secured to the bottom of a back or main body panel to form a pocket between them for reception of a paper label or the like. The cover member has a height such that its top edge is releasably engaged or “locked” behind a downwardly extending lip on the top of the main body panel, which lip is in line contact engagement with the cover member. A forwardly extending channel-shaped formation is provided along the top edge of the cover, comprising an inner downwardly extending limb and an outer upwardly extending limb between which the top lip of the main body panel is received when the cover is “locked” in position. The outer limb forms a gripping element by which the top edge of the cover can be disengaged from behind the top lip by finger pressure exerted from above, downwardly and outwardly on the upper edge of the outer limb. The construction of the '632 patent is inexpensive to manufacture and efficient in use. However, for certain applications it may be desirable to provide means that directly and releasably secure the cover to the main body panel without requiring a downward hinge pressure and provide a locking arrangement with greater contact area between the interengaging locking elements than a line contact.

In the '112 patent, a combined label and sign holder is disclosed, but without a locking mechanism between the back main body panel and the transparent cover. A pair of sign holder-receiving lip members is formed on the cover member to provide for the capturing of a sign. A pocket is formed between the cover member and main body panel and the cover member can be opened to receive a label. It has been found that the locking mechanism of the '632 label holder patent can be utilized with the combined label/sign holder of the '112 patent. One such product is the OMNI™ channel system of Fast Industries, Ltd., the assignee of the present application, which system is available in various embodiments that attach to C-channels, or directly to a shelf supporting surface by double-sided tape or similar adhesive.

Locking mechanisms for label holders have also been proposed that are the subject of U.S. patent application Ser. No. 10/216,197 filed Aug. 12, 2002, now U.S. Pat. No. 6,862,826 issued on Mar. 8, 2005, and also assigned to the assignee of the present invention. The locking mechanisms of this application are primarily ball and socket interconnections or other arrangements where the opening of the cover member with respect to the back main body portion is provided by generally downward movement on a release element extension of the cover member.

### SUMMARY OF THE INVENTION

It is an object of this invention to provide a novel locking mechanism for releasably securing the cover member of a plastic price channel of the type described above to the main body portion so as to retain a paper label or the like in a pocket formed between the main body portion and the cover member. A gripping or release element integral with the cover member facilitates release of the locking mechanism when access is required to the label-receiving space behind the cover member.

More specifically, it is an object of the present invention to provide a locking mechanism for a label holder or combined label/sign holder having a back or main body panel and a cover member wherein the locking mechanism is formed from two substantially parallel planar ridges that face each other and extend along the complete length of the main body panel and cover portion and which provides a greater locking surface area than a line contact engagement. The ridge associated with the back main body panel extends from an extension of the back main body panel to overly and enclose the opening between the cover member and back panel. Further, this ridge associated with the overhanging extension lies outwardly from the ridge associated with the cover member. Disengagement or release of the locking mechanism occurs by the opposing projections flexing independent of the direction of force acting on the cover member.

It is a further object of the present invention to associate the locking mechanism with a plurality of various oriented release elements to enable disengagement of the locking element regardless of the direction of application of force on the release element. That is, the release element can be oriented substantially perpendicular to the cover member or inclined upwardly or downwardly and release can be accomplished by upward, downward, or horizontal movement of the release element.

Other and further objects, features and advantages of the invention will become apparent from the ensuing description and claims taken in conjunction with the attached drawings.

### BRIEF DESCRIPTION OF THE DRAWINGS

FIG. 1 is a side view of a combined label and sign holder with the opposed ridge locking mechanism and an outwardly extending release element;

FIG. 2 is a side view of a label/sign holder with opposed ridge locking mechanism and outwardly and downwardly extending release element;

FIG. 3 is a side view of a label/sign holder with opposed ridge locking mechanism and an outwardly and upwardly extending release element;

FIG. 4 is a perspective view of a label/sign holder with the locking mechanism of FIG. 2; and

FIG. 5 is a side view of a label/sign holder positioned “upside-down” with the locking mechanism at the bottom.

Like reference characters refer to like parts throughout the several views of the drawings.

### DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

In the accompanying drawings, FIG. 1 shows an embodiment of a combined label/sign holder 10, generally comprising a back or main body panel 12, and a transparent cover member 14 is provided form a pocket, when opened, to retain a label as is known in the art. The main body panel 12 and cover member 14 are integrally or co-extruded to form a resilient bight or hinge connection 16 enabling the cover member 14 to be tipped forwardly for access to the pocket formed between the back main body panel 12 and cover member 14 to insert or remove a paper or plastic label (not shown) when the locking mechanism 100 (to be described) is disengaged. As is known in the art, the label/sign holder 10 is elongated and extends a substantial length, such as up to four feet or more in length. The label/sign holder is typically an extruded PVC material. Preferably, the main body panel 12 is of a darkened color and the cover member 14 is transparent.

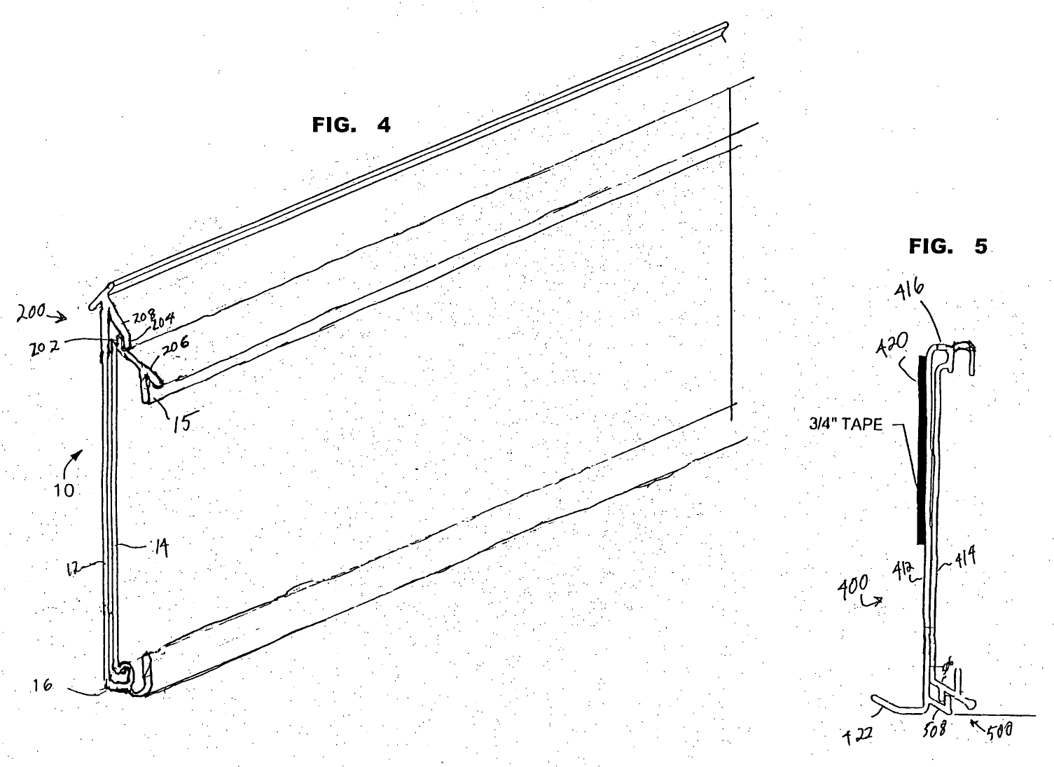

In the embodiment shown in FIG. 1, the main body panel 12 includes a means 20 for engaging the label/sign holder 10 on a shelf channel (not shown). The specific means for engaging shown in FIG. 1 is known as the “907” connection wherein an arcuate downwardly extending member 22 with a free end engages an outwardly-facing lip on a shelf channel (not shown) and the curved arm 24 wraps around the channel to provide a biasing force on the rear portion thereof. This “907” connection is only one of several forms of engaging means that could be utilized with the present invention, including an H-back connection (not shown) or many other engagement mechanisms for interconnection with shelf components such as C-channels. In addition, as shown in the embodiment of FIG. 5, to be described, an adhesive tape 420 can be affixed to the back of the main body panel 412 to retain the label/sign holder to a face of a shelf support member. The specific means for engaging, connecting or attaching the label/sign holder is not per se the novel feature of the present invention.

Although the various embodiments depicted in the drawings are all shown as label/sign holders similar to those described in the '112 patent and the OMNI™ product of Fast Industries, it should be understood that the novel locking mechanisms of the present invention can apply equally to a label holder that includes simply a transparent window or cover member overlying a back main body panel as is disclosed in the '632 patent and in U.S. Pat. No. 6,862,826. Indeed, as used herein, whenever the term “label holder” is used, it refers to both a label holder and a combined label/sign holder of the types described in the previously-identified patents and co-pending patent application, all of which are incorporated by reference herein.

The locking mechanism 100 shown in FIG. 1 includes two planar elongated parallel ribs or ridges 102, 104 integrally formed with the cover member 14 and with an extension 108 of the main body 12, respectively. These ridges extend the entire length of the label holder. Ridge 102 is integrally formed with the cover member 14 and is substantially parallel to the cover member 14. As shown, the cover member 14 includes an extension 106 which lies substantially perpendicular to and is outward from the cover member 14. This extension defines a release element. The ridge 102 is substantially perpendicular to the release element 106 and is offset slightly from the plane of the cover member 14. It should be appreciated that the ridge 102 can be coplanar with the cover member 14 instead of shifted laterally outward with respect thereto as is shown in FIG. 1.

The ridge 104 is integrally formed with the main body portion 12 and is substantially parallel therewith. It extends from extension 108, the latter of which lies perpendicular to the main body portion and parallel to the release element 106. It is thus seen that the extension 108 forms a cover portion over the opening defined by the main body portion 12 and cover member 14 which can protect against liquid spills from above. The ridge 104 extending downward from the extension or cover member 108 is in facing and engaging relationship with the ridge 102 and forms the lock mechanism.

The release element 106 includes a bulbous end 110 which can be gripped to be pulled in an outward direction or can, by finger pressure, be pushed down or pulled up to provide the disengagement. Disengagement requires a force vector component in an outward direction, but this force vector component can result from movement of the release member at its bulbous end 110, not only outwardly and downwardly, but also upwardly.

The downwardly extending portion 15 from the release member 106 is a lip member that is part of the sign holding mechanism and forms no part, specifically, of the release element 106 or the locking mechanism 100, generally. When the label holder does not include a sign holder function, this extension 15 would typically be eliminated.

The plastic material from which the elements of the locking mechanism are formed is the same or similar to those used to form the cover member 14 and back main body portion 12, and are sufficiently resilient so that the ridges 102 and 104 can deform as the cover member is opened and closed with respect to the main body portion 12.

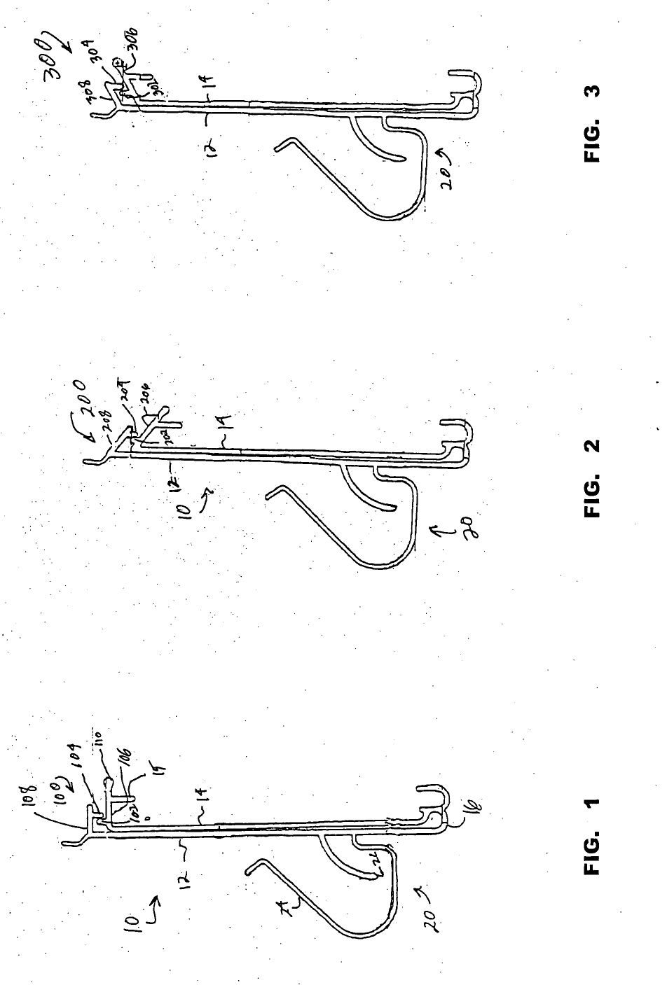

FIG. 2 shows a label/sign holder 10 with engaging means 20 identical to that of FIG. 1, but having a locking mechanism 200 modified to accommodate a downwardly and outwardly extending release element 206. The overhanging cover extension 208 from the main body portion 12 is outwardly and downwardly disposed with respect to the main body portion 12 and lies parallel to the release element 206. Ridges 202 and 204 are provided and are substantially parallel to cover member 14 and main body portion 12, respectively. In this embodiment, the release element 206 may be pulled or deformed downwardly or upwardly and, so long as there is at least a force component in an outward direction, the parallel ridges 202, 204 will deform and release from interlocking engagement. The locking mechanism 200 of the label/sign holder shown in FIG. 2 in side view is depicted in a perspective view of FIG. 4.

FIG. 3 is a label holder of the same general configuration as FIGS. 1 and 2, i.e., with a main body panel 12, a transparent cover member 14, and a shelf engaging mechanism 20. It differs by the locking mechanism 300. Here, the flexible extending and co-acting ridge members 302, 304 are connected, respectively, to extensions 306 and 308 which lie parallel to each other and extend outwardly and upwardly from their respective cover member 14 and back main body panel 12. As in the previous embodiments, the overhanging extension 308 from the main body panel 12 overlies the opening between the panels 12 and 14, and lies parallel to the release element 306 extending from the cover member 14. As in the previous embodiments, the ridges 302, 304 lie parallel to their respective cover member 14 and main body panel 12, respectively. Engagement and disengagement occurs with a force vector outwardly to distort the free ends of each of the ridges. The release member 306 includes a bulbous portion and disengagement can take place with upward, downward or outward movement.

FIG. 5 depicts a label/sign holder 400 that is similar in shape and function to the label/sign holders of the embodiments discussed above, except it is intended for mounting in a manner such that the hinge portion 416 now lies at the top. This provides further protection against spills and requires that the main body panel 412 and cover member 414 be opened from the bottom. In this embodiment, the main body panel 412 is affixed to a shelf portion by adhesive means, such as a ¾ tape 420. Note also the provision of a guide element 422, which is well known in the art. In this embodiment, the locking mechanism 500 is an upside-downward upward locking element of the type shown in FIG. 3. That is, the release element 506 lies at an obtuse angle with respect to cover member 414. Similarly, the extension 508 lies at an obtuse angle with respect to main body panel 412. When disposed in an upside-down configuration, it is seen that the release element 506 is angled outwardly and downwardly and the extension 508 is parallel thereto. It should be appreciated that the other locking mechanisms, such as those shown in FIGS. 1 and 2, can be utilized with a bottom opening label/sign holder 400.

It is a characteristic of each of the above embodiments that locking and retention is formed by a pair of parallel ridges having planar faces that face each other and are in planar contact. The planar faces provide a greater locking surface area than the point or line-type locking as shown in the '632 patent.

The foregoing descriptions and drawings should be considered as illustrative only of the principles of the invention. Numerous applications of the present invention will readily occur to those skilled in the art. Therefore, it is not desired to limit the invention to the preferred embodiments or the exact construction and operation shown and described. Rather, all suitable modifications and equivalents may be resorted to, falling within the scope of the invention.

1. An elongated label holder for carrying and displaying merchandise labels, comprising a main body panel having a top edge, a bottom edge, a front surface and a back surface, a transparent cover member having a top edge, a bottom edge, a front surface and a back surface, at least one of the top edges and bottom edges of the main body panel and the cover member being resiliently interconnected to define a hinge, a pocket being formed between the front surface of the main body panel, and the back surface of the cover member for removably receiving labels to be displayed through the cover member, the improvement which comprises a locking system for releasably retaining the cover member to the main body panel, said locking system comprising,
a first ridge integral with the main body panel and having a planar face parallel to said main body panel and spaced therefrom, a second ridge integral with said cover member and having a planar face parallel to said cover member and spaced therefrom, said planar face of the main body panel lying in facing relationship to said planar face of said cover member and in substantially planar contact therewith, each of said first and second ridges being sufficiently resilient so as to deform as the cover member is opened and closed with respect to the main body panel.

2. The label holder of claim 1, wherein said cover member includes a release element for disengaging the cover member from the main body panel.

3. The label holder of claim 2, wherein said second ridge extends from said release element.

4. The label holder of claim 2, wherein said main body panel includes a cover portion, and said first ridge extends from said cover portion.

5. The label holder of claim 4, wherein said cover portion extends over the pocket formed between the main body panel and cover member.

6. The label holder of claim 4, wherein said release element and said cover portion are parallel to each other.

7. The label holder of claim 6, wherein said release element and said cover portion are perpendicular to said cover member and main body panel, respectively.

8. The label holder of claim 1, wherein said planar faces are in planar contact over substantially their entire areas.
